(19) United States
(12) Patent Application Publication
(10) Pub. No.: US 2011/0119984 A1
(43) Pub. Date: May 26, 2011

(54) Structure to conceal fishhook inside false fish

(76) Inventor: Tsung-Hsi Tsai, Changhua City (TW)

(21) Appl. No.: 12/149,004

(22) Filed: Apr. 24, 2008

(51) Int. Cl. A01K 83/02; A01K 85/00

(52) U.S. Cl. 43/35

(57) ABSTRACT

A structure to conceal fishhook inside false fish is disclosed by that two false fishes being combined to disguise as a real fish for hooking fish is formed with a locking space for lockingly housing two locking plates having a chamber for concealingly housing a fishhook dispenser and tying device, wherein an axle ring of one or several hooking bodies and one end of an elastic member are lockingly fixed by an axle with axle hole as the axis center, and a double ring member is pulled to move up for a distance by the fishing line from the pull-opening made at top end of upper part thereof to drive fishhooks to spring out of side spring out openings thereof so as to hook fish mouth precisely and to recover by elastic recovery force of said elastic member thereby achieving the effectiveness of safety and repeated use.

### BACKGROUND OF THE INVENTION

(a) Field of the Invention

The invention is related to a structure to conceal fishhook inside false fish which is disclosed by that a fishhook dispenser and tying device is concealed inside the false fish which appears like a real fish in a bright color fish embodiment for attracting fish gathering, when fish is hooked by seduction, said false fish hold in fish mouth is pulled so that said double ring member is pulled by fishing line to move up a distance thereby driving one or several double locking elements and the elastic member to further drive the fishhooks of one or several hooking members to expose out of side spring out openings thereof so as to hook fish mouth precisely and to recover by the elastic recovery force of said elastic member thereby achieving the field or art for safety and repeated use.

(b) Description of the Prior Art

In general, false fish is used as an auxiliary tool for fishing, the false fish is painted with brightly colors, while in the water, it swims around like a real fish to attract fishes to come near and the false fish is attached with one or several fishhooks to seduce the fish to be hooked by the feeding stuffs on the fishhook.

### SUMMARY OF THE INVENTION

### I. Solutions to the Problems

1. The conventional false fish relies on its bright colors and feeding stuff on its fishhooks to attract fish gathering and to promote the probability of fish hooking. However, external sides of said false fish are tended to be hidden by the one or several fishhooks attached thereon, and it is more obvious when said one or several fishhooks are further attached with feeding stuffs thereby destroying the original purpose of seduction and resulting in a counter effect of minor issues overwhelming major ones.
2. The false fish for attracting fish gathering is usually attached with one or several fishhooks which may sometimes hook on unknown drifting things flowing with the stream on water surface, and if so, said false fish is required to be lifted up, rearranged and put in water again that may somehow affect emotional feelings of the worker.

### II. Method of Solutions

1. The invention is disclosed by that a fishhook dispenser and tying device is concealed inside a chamber combined by two locking plates which are further contained in a locking space combined by two false fishes and one end of a double ring member is stretched out of the pull-opening thereof to connect with a fishing line, wherein as said fishhook dispenser and tying device is concealed inside the false fish which is swung by water flow to appear like a real fish in a bright color fish embodiment for attracting fish gathering, when fish is hooked by seduction, said false fish hold in fish mouth is pulled so that said double ring member is pulled by fishing line to move up a distance thereby driving one or several double locking elements and one end of an elastic member to move upward and further driving clipping hole of one or several hooking members with axle as the axis center to force fishhooks to spring out of said spring out openings at two sides thereof to allow said two fishhooks to accurately hook the fish mouth and achieving the purpose of hooking fish precisely while providing the original seducing effect.
2. The invention is disclosed by that a fishhook dispenser and tying device is concealed inside a combined false fish, wherein due to the recovery force function of the elastic member, said fishhook dispenser and tying device is at tying status in ordinary conditions to avoid exposing the fishhook externally and can be recovered to the concealed tying status after a free dispensing status thereby providing a long-term fishhook concealment to avoid hooking foreign objects mistakenly as well as safe operation and effectiveness of repeated use.

### BRIEF DESCRIPTION OF THE DRAWINGS

FIG. 1 is a perspective decomposition view of the invention.

FIG. 2 is a perspective assembly view of the invention.

FIG. 3 is a cross-sectional view showing that the fishhook dispenser and tying device is tying in the embodiment of the invention.

FIG. 4 is a cross-sectional view showing that fishhook dispenser and tying device is dispensing in the embodiment of the invention.

### DETAIL DESCRIPTION OF THE PREFERRED EMBODIMENTS

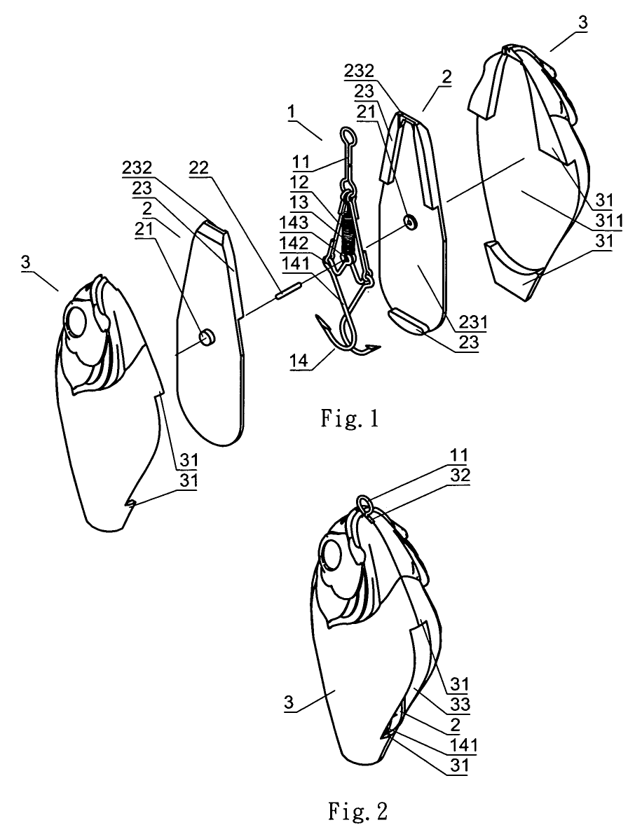

As shown in FIGS. 1 and 2, the invention comprises a fishhook dispenser and tying device 1, two symmetrical locking plates 2 and two false fishes 3, wherein said fishhook dispenser and tying device 1 having a double ring member 11 as the pulling end is stretched out of the pull-opening 32 of false fish 3 to connect with fishing line A at one end thereof, and is stretched deeply inwardly to inter-lockingly connect with one or several double locking element 12 and one end of elastic member 13 at the other end thereof. Said double ring member 11 and two ends of said double locking element 12 can be made to circular, quadrilateral, triangular, or hooking geometric shapes, and said elastic member 13 can be a spring, etc to be installed with one or several hooking members 14 at the bottom thereof with end sections of fishhooks 141 being bended to form a clipping hole 142 respectively to lockingly connect with another end of said double locking element 12 and being continuously further extended for a distance to appear an inclination for attaching with an axle ring 143 at rear end thereof to be penetratingly connected with another end of said elastic member 13 by axle 22. In addition, said device is installed inside chamber 231 clippingly combined by two locking plates 2. Said two locking plates 2 are respectively made with an axle hole 21 at a proper position at the center thereof for an axle 22 to penetratingly connect with axle ring 143 at the rear end of one or several hooking bodies and to lockingly affix another end of elastic member 13, while inner sides of upper and lower parts thereof are respectively made with inner rim plates 23 to form a chamber 231 which not only increases the contact area for locking combination, but also has the benefit to enhance the structural strength of and protection for fishhook dispenser and tying device 1, further top end of inner rim plate 23 at upper part thereof is made with a breach opening 232 which becomes pull-opening 32 after said two locking plates are combined, and a spring out opening 33 is formed at one side or both sides of the middle part thereof, while the other side is made with an inner rim plate 23 to connect with the inner rim plates 23 at upper and lower parts thereof, and the whole locking plate combination is housed inside the locking space 311 enclosed by two false fishes 3. Said two false fishes 3 with bright color external sides are combined to appear a fish shape for attracting fish gathering and hooking fish, and are formed with a locking space 311 by installing outer rim plates 31 at inner sides of upper and lower parts thereof for lockingly housing locking plates 2, further, top ends of outer rim plates 31 at upper part thereof is made with a pull-opening 32 similar to the one of locking plates 2, and one or two sides of middle part are also formed with a spring out opening 33, while the other side is made with an outer rim plate 31 for connection with outer rim plates 31 at upper and lower parts.

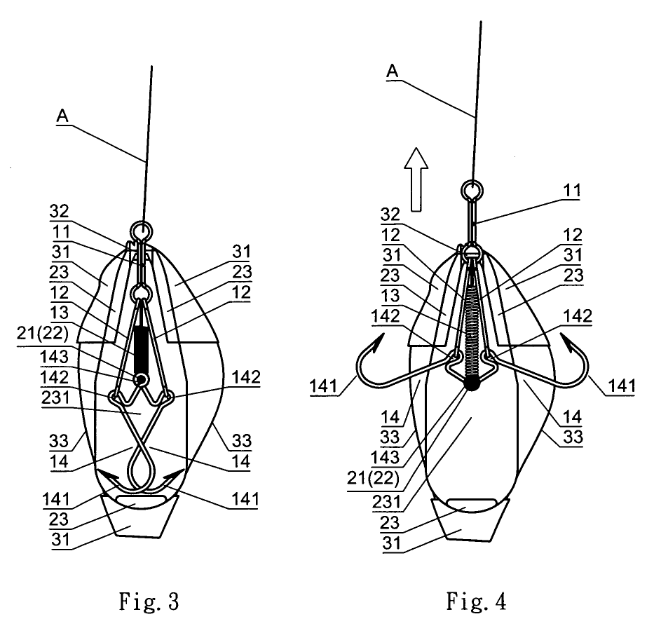

FIGS. 2, 3 and 4 show a preferred embodiment, wherein one of double ring members 11 is stretched out of pull-opening 32 to connect with a fishing line A, wherein as fishhook dispenser and tying device 1 is concealed inside false fish 3 which is swung by water flow to appear like a real fish with two bright color external sides for attracting fish gathering, when fish is hooked by seduction, said false fish hold in fish mouth is pulled so that double ring member 11 is pulled by fishing line A to move up a distance thereby driving two double locking elements 12 and one end of a spring to move upward and further driving clipping hole 142 of two hooking members 14 with axle 22 as the axis center to force fishhooks 141 to spring out of two side spring out openings 33 thereof to allow two fishhooks 141 to accurately hook the fish mouth, and once removed, due to elastic recovery force of the spring, fishhook dispenser and tying device 1 is recovered back to concealing status for fishhooks 141, hence it allows fishhooks 141 to be concealed in ordinary times to avoid hooking foreign objects mistakenly thereby ensuring safety in usage and achieving the effectiveness of hooking fish accurately.

The invention is by concealing fishhook dispenser and tying device 1 inside false fish 3 to allow one end of double ring member 11 to connect with the fishing line A, so that when false fish 3 is hold and pulled by a fish, fishhook dispenser and tying device 1 is then continuously towed to accurately hook fish mouth thereby achieving the practical benefits of safety and repeated use.

I claim:

1. A structure to conceal fishhook inside false fish is characterized in that:
A fishhook dispenser and tying device having a double ring member as the pulling end to connect with fishing line at one end thereof, and is stretched inwardly to inter-lockingly connect with one or several double locking element and one end of elastic member at the other end thereof, further, one or several hooking members 14 are installed at the bottom thereof with end sections of fishhooks being bended to form a clipping hole respectively for locking connection with another end of double locking element and being continuously further extended for a distance to appear an inclination for attaching with an axle ring at rear end thereof;
the two locking plates are respectively made with an axle hole at a proper position at the center thereof for penetration through by an axle, inner sides of upper and lower parts thereof are respectively made with inner rim plates to form a chamber, top end of inner rim plate at upper part thereof is made with a breach opening which becomes pull-opening after two locking plates are combined, and a spring out opening is formed at one side or both sides of the middle part thereof, while the other side is made with an inner rim plate to connect with the inner rim plates at upper and lower parts thereof;
Said two false fishes with bright color external sides are combined to appear a fish shape for attracting fish gathering and hooking fish, and are formed with a locking space by installing outer rim plates at inner sides of upper and lower parts thereof, top ends of outer rim plates at upper part thereof is made with a pull-opening, and one or two sides of middle part are also formed with a spring out opening, while the other side is made with an outer rim plate for connection with outer rim plates at upper and lower parts;
therefore, as two locking plates are lockingly combined inside the locking space formed by two false fishes, fishhook dispenser and tying device is concealed inside said false fish, when fish is hooked by seduction, said false fish hold in fish mouth is pulled so that double ring member is pulled by fishing line to move up a distance thereby driving double locking elements and elastic member to move upward and further driving hooking members with axle as the axis center to force fishhooks to spring out of side spring out openings so as to allow fishhook to accurately hook the fish mouth and rely on the elastic recovery force of elastic member thereby achieving the practical benefits of safety and repeated use.

2. The structure to conceal fishhook inside false fish as claimed in claim 1, wherein double ring member and two ends of double locking element can be made to circular, quadrilateral, triangular, or hooking geometric shapes.

3. The structure to conceal fishhook inside false fish as claimed in claim 1, wherein number of double locking elements and hooking members can be a plural.

4. The structure to conceal fishhook inside false fish as claimed in claim 1, wherein the elastic member can be a spring.
